(19) United States
(12) Patent Application Publication
(10) Pub. No.: US 2007/0178237 A1
(43) Pub. Date: Aug. 2, 2007

(54) Method for patterning coatings

(76) Inventors: Dong Myung Shin, Daejeon Metropolitan City (KR); Ji Su Kim, Daejeon Metropolitan City (KR); Dae Hyun Kim, Goyang-si (KR); Sung Hyun Kim, Daejeon Metropolitan City (KR); Kyung Soo Choi, Cheongju-si (KR); Hee Kwan Park, Daejeon Metropolitan City (KR); Jung Ae Ahn, Incheon Metropolitan City (KR); Jae Ik Choi, Daejeon Metropolitan City (KR); Sang Moon Yoo, Daejeon Metropolitan City (KR); Yoon Hee Heo, Seoul (KR); Han Soo Kim, Seoul (KR); Jeong Ae Yoon, Masan-si (KR)

Correspondence Address: MCKENNA LONG & ALDRIDGE LLP;Song K. Jung, 1900 K Street, N.W., Washington, DC, 20006, US

(21) Appl. No.: 11/496,026

(22) Filed: Jul. 31, 2006

(30) Foreign Application Priority Data
Aug. 2, 2005 (KR) 10-2005-0070619
Aug. 12, 2005 (KR) 10-2005-0074144

(51) Int. Cl. B05D 5/00; B05D 3/12; B05C 1/00

(52) U.S. Cl. 427/355; 427/256; 427/58; 118/211

(57) ABSTRACT

The invention provides a method for patterning coatings which includes the steps of: a) applying coatings onto a flat plate; b) allowing the coatings applied to the flat plate to contact with protrusions of a substrate so as to transfer portions of the coatings on the flat plate which contact with the protrusions of the substrate to the protrusions of the substrate from the flat plate, the substrate having unevenness formed with the protrusions and grooves; and c) allowing the coatings remaining on the flat plate or on the protrusions of the substrate to contact with a print surface of a print object so as to transfer the coatings to the print object. The method has simple processes, and ensures high precision and high speed in patterning functional materials, preferalby, electronic materials.

### TECHNICAL FIELD

The present invention relates to a method of patterning coating by which functional materials are evenly fine-patterned with high precision and speed, the functional materials having conductive or optical characteristics used for constituting integral components of electronic devices such as electromagnetic recording device, imaging device, and circuit device, for example, a semiconductor circuit or a color filter of a TFT-LCD or plasma display where fine patterning is required.

This application claims priority from Korean Patent Application No. 10-2005-0070619 filed on Aug. 2, 2005 and No. 10-2005-0074144 filed on Aug. 12, 2005 in the Korean Intellectual Property Office, the disclosure of which is incorporated herein by reference in its entirety.

### BACKGROUND ART

As an electronic apparatus decreases in size, demand for high integration of electronic components is increasing. Precision of tens of microns or less is needed in accordance with purposes of patterning of electronic materials. Photolithography that is widely used can provide the above-described high precision.

Particularly, photolithography is widely used as a method of fine-patterning functional materials for forming a color filter or semiconductor circuit in a TFT-LCD industry which leads a display industry recently, or a plasma display field or a semiconductor display.

However, many problems are found in photolithography. That is, photolithography is very complex to implement, because photolithography should include the steps of: forming a photoresist layer on an electronic material layer to be patterned, selectively exposing the photoresist layer and developing the photoresist layer, and patterning the electronic material layer and removing the photoresist layer.

Further, manufacture equipment is expensive, and the size of the equipment is big. Furthermore, coatings of materials are applied to parts where coatings are unnecessary, which leads to waste.

Moreover, photosensitive materials which respond to light of short wavelength should be mixed into the electronic materials in order to ensure processibility of the above-described method, which causes cost price of material and degrades conductive, electromagnetic, and optical characteristics of the electronic materials.

Particularly, materials like a resist used in the above-described method should include various photosensitive materials and coating assistant materials in order to ensure processibility of the method, which leads to high cost of material and low stability of storage. In the method, time and money are excessively required in order to quantify the sensitivity of material like a resist.

Besides the photolithography, a roll printing method is known. The roll printing method is a printing method that is converted from a conventional method and applied to transferring patterns of electronic materials, in which a blanket wound around a roll is sequentially rolled on a substrate having grooves that the electronic materials fill and a print object.

In the roll printing method, processes of exposing, developing, etc. can be excluded, and it is unnecessary to add photosensitive substance to materials to be patterned, and the processes are simple to perform and the size of equipment can be significantly decreased.

However, because the roll printing technology is initially used as a print method to publish magazines and books having a small print area, it has limitations to be applied to forming patterns of electronic materials on a large substrate.

First, in the roll printing method, patterns to be formed hugely depend on conditions of a roll, such as speed and direction, and the thickness of electronic material to be patterned, and pressure to be applied to the roll, and problems like pattern distortion are found when patterns are transferred from a curved surface of a cylindrical roll to a flat plate.

Further, in order to obtain uniform coating of electronic materials, many variations resulting from control of precision and thickness of a roll, and positional and angular control of a nozzle during coating of the electronic material should be taken into account.

To be more specific, it is difficult to form the roll to be used in the roll printing method with high precision, and it is difficult to evenly attach the blanket to the roll because of the distortion due to curvature of a roll body; therefore, coating liquid cannot be evenly applied on the blanket. For this reason, coating is not applied to the entire surface leaving some portions uncoated, and the coating partially remain on some portion, which hinders in forming perfect patterns.

Furthermore, the worst defect of the method comes from the fact that as a roll increases in size, the roll is likely to bend due to the weight of the roll. Gear wheels provided at both sides of the roll which function to roll the roll are easily worn and deformed. Accordingly, it is impossible to keep a constant interval between the surface of the roll and the print object. In addition, it takes too much time to apply the method to a large substrate.

Because of the above-described problems, the roll printing method is not widely used in the recently developed processes, and the photolithography method having the aforementioned defects is rather used. Therefore, it is required to develop a method of patterning functional materials to solve the above-described problems.

### DISCLOSURE

[Technical Problem]

As described above, in the related art, problems are found in processiblilty, cost, coating uniformity, precision, and speed control, when functional materials like electronic materials are fine-patterned.

Therefore, an object of the present invention is that it provides a method of patterning functional materials which ensures simple processes, low cost, coating uniformity, high precision and high speed.

[Technical Solution]

According to an aspect of the invention, the invention provides a method for patterning coatings including the steps of:
a) applying coatings onto a flat plate;
b) allowing the coatings applied to the flat plate to contact with protrusions of a substrate so as to transfer portions of the coatings on the flat plate which contact with the protrusions of the substrate to the protrusions of the substrate from the flat plate, the substrate having unevenness formed with the protrusions and grooves; and
c) allowing the coatings remaining on the flat plate or on the protrusions of the substrate to contact with a print surface of a print object so as to transfer the coatings to the print object.

According to another aspect of the invention, the invention provides a method for patterning coatings including the steps of:
a) filling coatings into grooves of a substrate;
b) allowing a flat plate to contact with the surface of the substrate having the grooves so as to transfer the coatings filled in the grooves to the flat plate; and
c) allowing the coatings transferred to the flat plate to contact with a print surface of a print object so as to transfer the coatings on the flat plate to the print object.

According to another aspect of the invention, the invention provides a method of manufacturing an electronic device, in which an electronic material is fine-patterned using the method of the invention so as to manufacture an electronic device.

According to another aspect of the invention, the invention provides an apparatus for patterning coatings including:

a flat plate which is provided so as to be movable in x-, y-, z-, and θ-axis directions with respect to a surface of the flat plate by a flat movement device;

a coater which is provided so as to be movable along a surface direction of the flat plate by a coater movement device so as to apply coatings onto the flat plate; and

a substrate which is disposed below the flat plate and includes protrusions,

wherein the flat plate is conveyed so as to contact with the substrate, the coatings on the flat plate is transferred to the protrusions of the substrate, and then the coatings remaining on the flat plate or on the protrusions of the substrate is transferred to a print object, thereby forming patterns.

According to another aspect of the invention, the invention provides an apparatus for patterning coatings which includes:

a flat plate which is provided so as to be movable in x-, y-, z-, and θ-axis directions with respect to a surface of the flat plate by a flat movement device;

a substrate which is disposed below the flat plate and formed with grooves capable of filling coatings therein; and

a filling amount control means which is provided in order that the coatings is exclusively filled in the grooves of the substrate,

wherein the flat plate is conveyed toward the substrate, in which the coatings is exclusively filled in the grooves by the filling amount control means, and the coatings filled in the grooves are transferred to the flat plate by pressing the flat plate against the substrate, and then the coatings on the flat plate are transferred to a print surface of a print object by conveying the flat plate, thereby forming patterns.

[Advantageous Effects]

According to the method of the invention, because coating, preferably, functional materials can be-directly transferred to a print object using a flat plate, processes are simple and cost is low, and high precision and high speed are ensured in patterning coating. As the method is applied to the process of patterning functional materials like electronic materials, productivity of electronic elements can be significantly improved.

### DESCRIPTION OF THE DRAWINGS

FIGS. 1 and 2 are views showing a process in which coating is applied to a flat blanket using a slot coater, according to an embodiment of the invention.

FIGS. 3 and 4 are views showing a process in which portions of the coating on the flat blanket are transferred to a substrate using the substrate, according to the embodiment of the invention.

FIGS. 5 and 6 are views showing a process in which the coating patterned on the flat blanket are transferred to a print object, according to the embodiment of the invention.

FIGS. 7 and 8 are views showing a process in which coating is applied to a substrate, and the coating is filled exclusively in grooves of the substrate using a doctor blade method, according to another embodiment of the invention.

FIGS. 9 and 10 are views showing a process in which a flat blanket is pressed against the substrate having the grooves having the coating filled therein, and the coating filled in the grooves of the substrate are transferred to the flat blanket, according to the embodiment of the invention.

FIGS. 11 and 12 are views showing a process in which the coating on the flat blanket is transferred to a print object, according to the embodiment of the invention.

FIG. 13 is a view showing a first flat movement device which moves a flat plate in an upward and downward direction (z-axis).

FIG. 14 is a view showing a second flat movement device which moves the flat plate in a right and left direction(y-axis), in a forward and backward direction(x-axis), and in a θ-axis direction.

FIGS. 15 and 16 are views schematically showing a coater and a coater movement device.

### EXPLANATION OF THE SIGNS THAT ARE THE MAIN PART OF THE DRAWINGS

1: slot coater
2,12 : flat blanket
3,13 : flat blanket support part
4,14 : substrate
4a,14a : protrusion
4b,14b : groove
4c,14c : substrate support part
5,15 : print object
5a,15a : print object support part
6,16 : support part fixing frame
,7b,7c,7d,17a,17b,17c : coatings
21 : first control screw
22 : movement support frame
23 : second control screw
24 : third control screw
25 : stepping motor
30 : coater mounting frame
31 : linear motor
   [Mode for Invention]

Hereinafter, the present invention will be described in detail. The present invention relates to a method of patterning coating, and the method of patterning coating is very simple, which is different from photolithography that should have the steps of: forming a target coating layer; forming a photoresist layer on a coating layer; selectively exposing the photoresist layer; patterning the photoresist layer by developing the photoresist layer; selectively etching the coating layer by using the patterned photoresist layer; and stripping the photoresist layer.

That is, according to an embodiment of the present invention, patterning coating on print object can be achieved by the steps of: coating coating on a flat plate; forming the shape of coating patterns directly and simply by using a substrate having a unevenness, and transferring the.patterned coating onto print object. On the other hand, according to another embodiment of the present invention, patterning coating on print object can be achieved by the steps of: filling coating in a groove portion of the substrate, pressing the flat plate against the substrate having the groove portion so as to transfer the coating filled in the groove portion to the flat plate, and transferring the coating on the flat plate to print object.

In the meantime, unlike the conventional roll printing method, a flat plate is used in coating in the present invention. When the flat plate increases in size, the increase of weight is small, as compared to the roll. Therefore, in the case of using the flat plate, it is possible to prevent problems due to the weight of the roll, for example, deformation of a gear wheel which functions as a roll or a wheel of a roll.

Further, the flat plate can be more easily processed with high precision than the roll, and does not have variation like curvature change of a roll. Therefore, in the case of attaching a blanket rubber, the blanket rubber can be attached more evenly and firmly; accordingly, coating liquid is applied to the flat plate.

Since the roll printing method includes rolling a roll in order to pattern coating, it is likely that the coating is transferred not only to the surface of a protrusion of the substrate but also to an edge or side of the protrusion; therefore, precision of coating to be transferred to print object is degraded.

However, when the flat plate is used according to a first embodiment of the present invention, the flat plate can come into vertical contact with the substrate having an unevenness, and the flat plate or the substrate having an unevenness can come into vertical contact with the print object. Otherwise, when a flat plate is used according to a second embodiment of the present invention, the flat plate can come into vertical contact with a substrate having a groove portion or print object. Therefore, with the method of the invention, it is possible to pattern coating with higher precision, as compared to the roll printing method.

Further, in the case of using the flat plate, coatings are pressed all at once to pattern the coating. Therefore, coating can be patterned by using the roll rolling method faster than the roll printing method.

In the patterning of functional materials like an electronic material, simplification, high precision, high speed of the aforementioned process have much effects on productivity of electronic elements. Nevertheless, a method of patterning coating by using a flat plate has not been known.

Hereinafter, the method of the present invention will be described with reference to the accompanying drawings. However, it should be understood that the above embodiments of the drawings are provided as exemplary embodiments of the present invention, are not intended to limit the scope of the present invention.

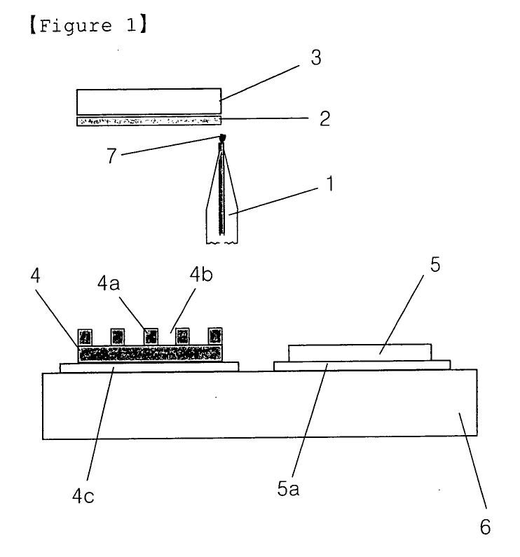

According to a first embodiment of the present invention, the method of the invention includes the steps of: a) applying coating onto the flat plate; b) bringing the coating applied to the flat plate into contact with protrusions of a substrate, the substrate composed of the protrusions and grooves, to transfer portions of the coating that are in contact with the protrusions of the substrate from the flat plate to the protrusions of the substrate; and c) bringing coating remaining on the flat plate or coating on the protrusions of the substrate into contact with an print surface of print object to transfer the coating to the print object. This embodiment is shown in FIGS. 1 to 6.

According to the embodiment, as shown in FIG. 1, the flat plate 2 and 3 includes a flat blanket 2, and a flat blanket support part 3 supporting the flat blanket 2.

The flat blanket 2 can be attached to the flat blanket support part 3 in vacuum, accordingly, the flat blanket 2 can be firmly fixed to the flat blanket support part 3.

The flat blanket 2 is composed of two layers, a first layer is formed of a soft silicon rubber material to which coating 7a are applied, and a second layer formed of a hard PET material in contact with the flat blanket support part 3. The flat blanket supporting part may be formed of hard and abrasion resistance materials such as stainless steel. The flat blanket 2 can be fixed to the flat plate blanket support part 3 by a wafer stationary vacuum absorber through a hole formed in the flat blanket support part 3, as the wafer stationary vacuum absorber draws the flat blanket 2 toward the flat blanket support part 3.

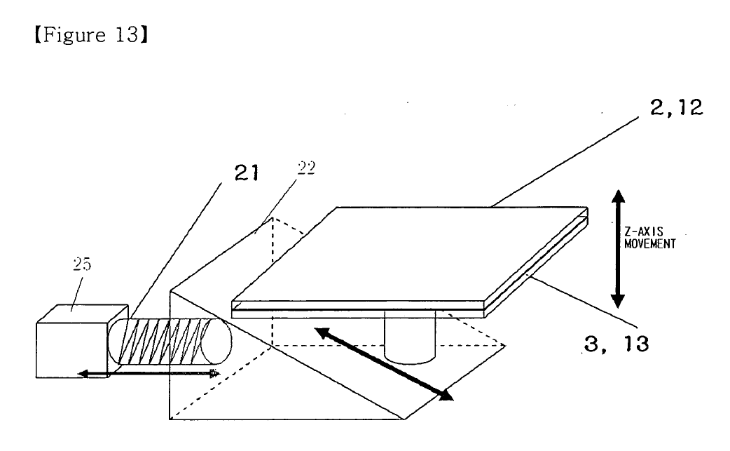

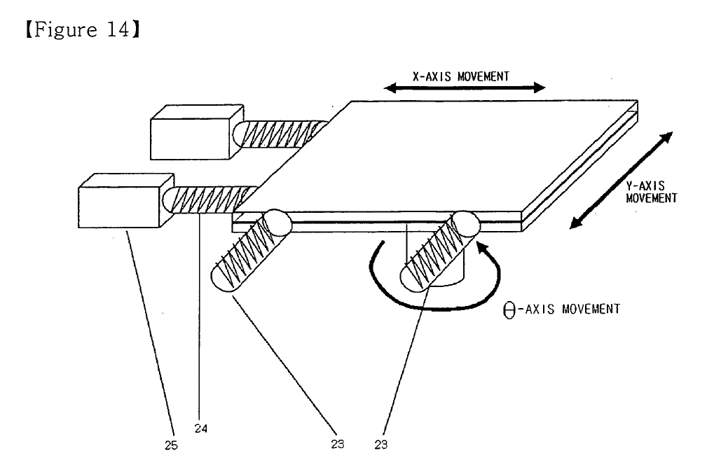

The flat plate 2 and 3 composed of the flat blanket 2 and the flat blanket support part 3, as shown in FIGS. 13 and 14, can accurately move in an upward and downward direction (z-axis; FIG. 13), in a right and left direction (y-axis; FIG. 14), in a forward and backward direction (x-axis; FIG. 14), and in a rotation direction (θ-axis; FIG. 14) by a flat plate movement device composed of a first movement device and a second movement device.

As for the first movement device of the flat plate, as shown in FIG. 13, a screw thread is formed in a movement support frame 22 of a pentahedron having a slope surface in a direction parallel to the bottom, a first control screw 21 is joined with the screw thread, and then rotation of the first control screw 21 is controlled, thus, the flat blanket support part 3 and 13 to which the flat blanket 2 and 12 is joined can move in the z-axis along the slope surface of the movement support frame 22. For example, when the first control screw 21 is rotated so as to be screwed into the movement support frame 22, the flat blanket support part 3 and 13 to which the flat blanket 2 and 12 is joined is pushed by the slope surface of the movement support frame 22 and moves in such a direction that approaches a substrate 4 and 14. As described above, it is possible to gradually move the flat plate 2, 3, 12, and 13 in such a direction (upward and downward) that approaches and distances from the substrate 4 and 14 by using the first movement device of the flat plate. In this case, although one first control screw 21 is provided, the number of the first control screw 21 is not limited to one.

As for the second movement device of the flat plate, as shown in FIG. 14, a fine screw thread is formed at the side surface of the flat blanket support part 3 and 13, a second control screw 23 and a third control screw 24 are joined with the screw thread, and then rotation of the second and third control screw 23 and 24 are controlled, thus, the flat blanket support part 3 and 13 to which the flat blanket 2 and 12 is joined can move in the right and left direction (y-axis) and the forward and backward direction (x-axis). Movement (rotation) in the θ-axis direction of the flat plate 2, 3, 12, and 13 is enabled by relatively controlling the second control screw 23 and the third control screw 24 of the flat blanket support part 3 and 13. In this case, although two second control screws 23 and two third control screws 24 are provided, the number of the second and third control screw 23 and 24 is not limited to two.

The flat movement device composed of the first and second movement devices may further include a stepping motor 25 which is joined with at least one of the first control screw 21, the second control screw 23, and the third control screw 24 and rotates at least one of the first control screw 21, the second control screw 23, and the third control screw 24. As each of control screws 21, 23, and 24 is rotated by driving the stepping motor 25, the position of the flat plate 2, 3, 12, and 13 can be minutely controlled. Otherwise, each of the control screws 21, 23, and 24 can be manually rotated. The flat movement device having the first and second movement devices is not limited to that of the drawing.

In the meantime, the flat movement device capable of moving the flat plate 2, 3, 12, and 13 composed of the flat blanket 2 and 12 and the flat blanket support part 3 and 13 may includes a transverse conveyance means which moves the flat plate 2, 3, 12, and 13 in the right and left directions, and a vertical conveyance means which moves the flat plate 2, 3, 12, and 13 in the upward and downward directions.

The transverse conveyance means includes a mounting frame having the flat plate 2, 3, 12, and 13 mounted therein and a linear motor which is joined with the mounting frame so as to transversely move the mounting frame. Otherwise, the transverse conveyance means may be a driving arm.

The vertical conveyance means includes a motor which generates power to vertically move the mounting frame having the flat plate 2, 3, 12, and 13 mounted therein, and a gear which transfers the power of the motor to the mounting frame. In other words, the flat plate 2, 3, 12, and 13 can be conveyed vertically by using the gear. On the other hand, the vertical conveyance means includes a motor which generates power to vertically move the mounting frame having the flat plate 2, 3, 12, and 13 mounted therein, and a piston which is movably installed in a cylinder by the power of the motor and connected to the mounting frame. That is, the flat plate 2, 3, 12, and 13 can be vertically conveyed by a piston method using pressure. Otherwise, the vertical conveyance means may be a driving arm.

In the meantime, because the flat blanket 2 is levelly attached to the flat blanket support part 3, it is possible to prevent the flat blanket 2 from bending, as compared to the case in which the blanket is attached to the roll.

It is preferable that the flat blanket is formed of materials which have lower absorptivity to coatings than materials of the substrate 4 having an unevenness 4a and 4b or the print object 5. Further, preferably, the flat blanket 2 has heteromorphism and resilience when pressure is applied thereto. For example, when glass is used as the substrate 4 having the unevenness 4a and 4b and the print object 5, the flat blanket 2 may be formed of silicon rubber. Polydimethylsiloxane is most typically known for silicon rubber. In addition, elastomer like polyurethane which is deformable when an external force is applied and is restored to the original shape after a predetermined time passes to create a system preserving energy. The elastomer can be used as material for forming the flat blanket. For example, the flat blanket can be obtained by mixing PDMS crude liquid with a curing agent and curing them on a surface plate. In this case, a spin and a slit type coater can be used to obtain a constant thickness. After curing, it is proper for the blanket to have hardness of Rockwell C scale 20 to 69, and the hardness can be controlled by changing density of polymer chain to be cured and an amount of additive if polyurethane is added to PDMS.

When the flat blanket support part 3 increases in size, the increase of weight is small, as compared to the case of using the roll. Therefore, the flat blanket support part 3 has higher durability, as compared to the case of using the roll. In addition, if the flat blanket support part 3 is formed in a thin shape by using inorganic materials such as natural stone like marble, which is not deformed due to gravity and its own weight, and ceramic or stainless steel, it is possible to further improve durability of the flat blanket support part 3. This is because the inorganic materials such as marble and ceramic are immune to deformation that occurs in metallic or polymer materials.

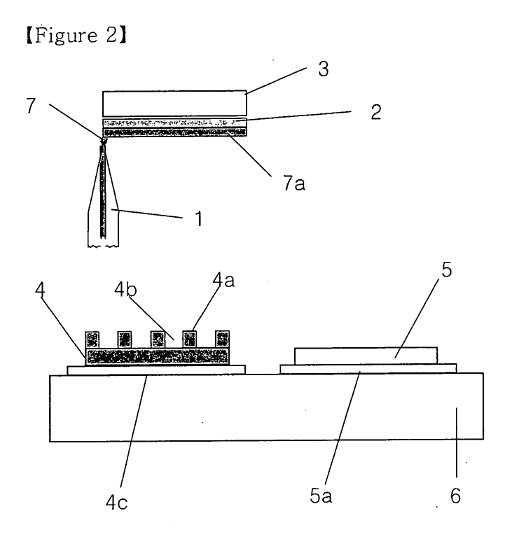

The method of the present invention includes coating the flat blanket 2 with coatings 7. The flat blanket 2 is coated with the coatings 7 of the coater 1, and the coatings 7a is accordingly formed as shown in FIG. 2.

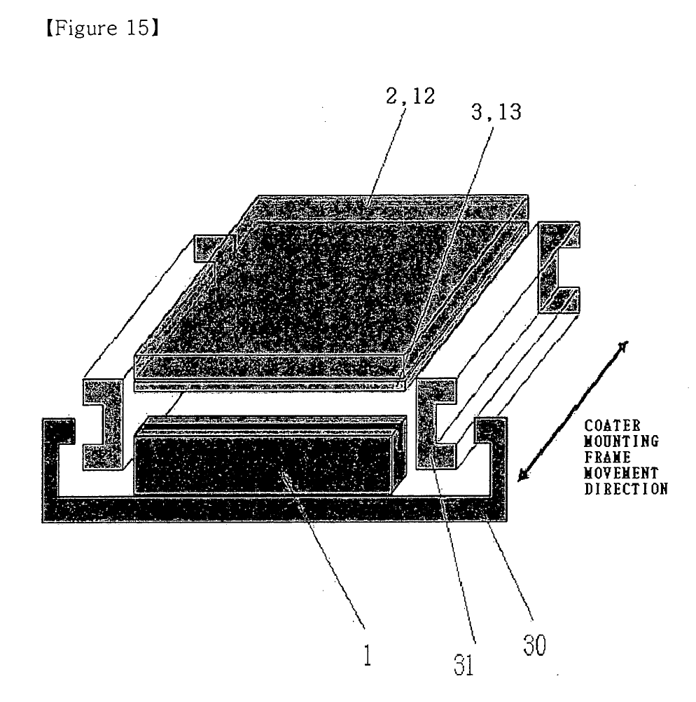

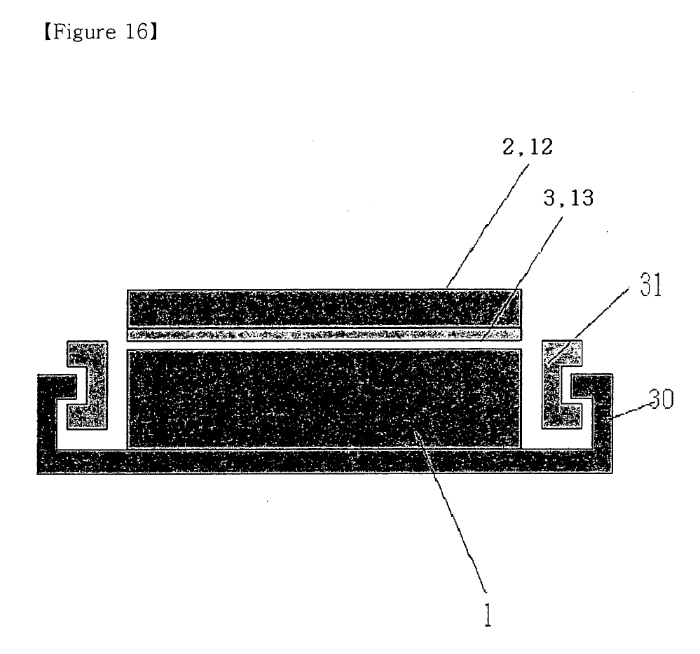

In the present invention, a capillary coater capable of sustaining coating uniformity or a slit coater is preferable used as the coater applying the coatings 7 to the flat blanket 2, but the coater is not limited thereto, and coating means well known in the art can be used. The coater 1 can apply the coatings 7 to the flat blanket 2 while being conveyed by a coater movement device. As shown in FIGS. 15 and 16, the coater movement device may be composed of the mounting frame 30 having the coater 1 mounted therein and a linear motor 31 which transversely moves the mounting frame 30. Otherwise, the coater movement device may be a driving arm.

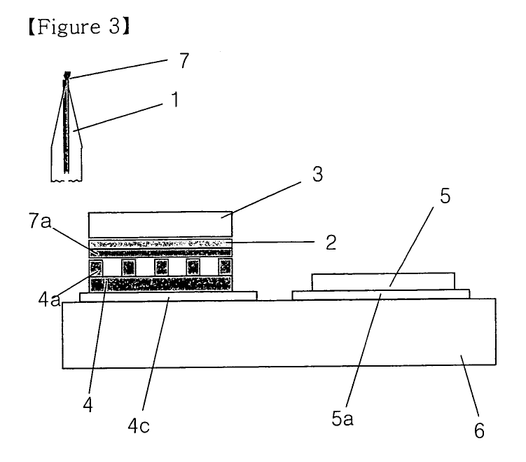

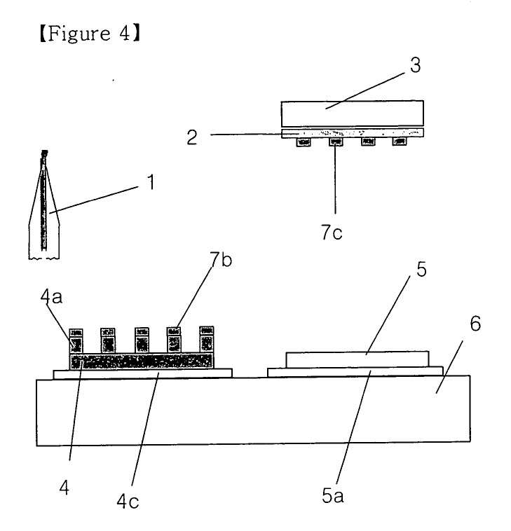

As shown in FIG. 3, after the coatings 7a of the flat blanket 2 are pressed against the protrusions 4a of the unevenness 4a and 4b of the substrate 4, the coatings 7a are divided at a contact surface as shown in FIG. 4; therefore, portions of the coatings on the flat blanket 2 which are in contact with the protrusions 4a of the unevenness 4a and 4b are transferred to the protrusions 4a of the substrate 4 from the flat blanket 2.

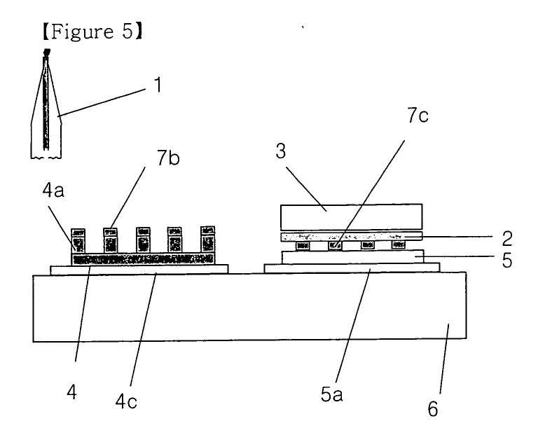

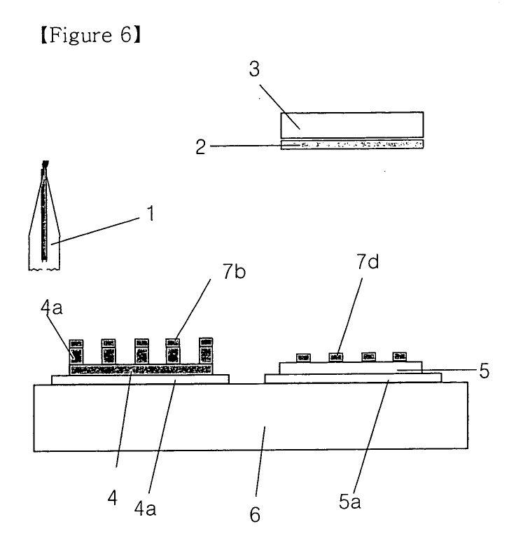

Subsequently, as shown in FIG. 5, the flat blanket 2 on which the coatings 7c remain is pressed against the print object 5, and the coatings 7c formed on the flat blanket 2 are transferred to the print object 5, and then if the coatings is divided at the contact surface, as shown in FIG. 6, coating patterns 7d are formed on the print object 5.

When the flat blanket 2 is pressed against the substrate 4 having the unevenness 4a and 4b, and when the flat blanket 2 is pressed against the print object 5, it is preferable that contact surfaces come into vertical contact with the contact surfaces.

It is possible to improve precision of coating patterns to be formed, when the contact surfaces come into vertical contact with the contact surfaces.

According to the embodiment, the substrate 4 having the unevenness 4a and 4b and the print object 5 can be formed of any materials, as long as they have higher absorptivity to coatings than the flat blanket 2.

However, because the flat blanket 2 should have heteromorphism when pressed, to effectively transfer ink, the substrate 4 having the unevenness 4a and 4b is preferably formed of metal, such as aluminum and stainless steel, or silicide, such as glass. Patterns having the depth of 0.1 to 100 μm are carved in the substrate 4, and the more fine the patterns are, the more precise patterns are obtained. Preferably, aspect ratio of width to depth of the pattern is in the range of 5:1 to 0.01:1, and as the aspect ratio of width to depth of the pattern becomes larger, processing will be difficult to perform, and danger of damage of the pattern will increase.

The material having the hard surface, such as glass, and the polymer material that has the flexible surface, such as polyethylene, polypropylene, or polyvinyl, may be used as the print object. Examples of the material of the print object include, but are not limited to a flexible plastic material such as polyester and PET applied to e-papers or flexible displays; a hard plastic material of polyurethane or epoxy applied to substrates of PCBS; or glass.

In the present invention, the substrate 4 having the unevenness 4a and 4b and the print object 5 can be disposed on a substrate support part 4c having the unevenness 4a and 4b and a print object support part 5a, and the substrate 4 having the unevenness 4a and 4b and the print object 5 can be attached to the support part 4c and 5a in vacuum.

The substrate 4 having the unevenness 4a and 4b and the print object 5 can be mounted on a support part fixing frame 6 that is disposed in a position required in the process by using the support parts 4c and 5a, the position of these can be fine-controlled by moving them the upward and downward, right and left, forward and backward, and rotation directions.

Positions of the substrate 4 having the unevenness 4a and 4b and the print object 5 may be controlled through the same procedure as the position control of the above-mentioned flat plates 2, 3, 12, and 13, that is, using the device shown in FIGS. 13 and 14. The substrate 4 having the unevenness 4a and 4b and the print object 5 may be moved in all directions including x-, y-, z-, and θ-axis directions as the above-mentioned flat plates 2, 3, 12, and 13, and the positions of the substrate 4 having the unevenness 4a and 4b and the print object 5 may be independently controlled according to the above-mentioned variables (x-, y-, z-, and θ-axis).

The support part fixing frame 6 functions to support the substrate 4 having the unevenness 4a and 4b and the print object 5 from below, and is capable of being moved in all directions including x-, y-, z-, and θ-axis directions. Thus, it is convenient to simultaneously move the substrate 4 having the unevenness 4a and 4b and the print object 5 by the same distance.

The substrate 4 having the unevenness 4a and 4b and the print object 5 may be moved using a movement device including a conveyer and a driving arm. That is, after the substrate 4 having the unevenness 4a and 4b and the print object 5 are conveyed to the support part fixing frame 6 using the conveyer, the substrate 4 having the unevenness 4a and 4b and the print object 5 are mounted on the support part fixing frame 6 using the driving arm, and fixed to the support part fixing frame 6 using a vacuum absorber.

Although the coatings 7c of the flat plate 2 and 3 are transferred to the print object 5 according to the embodiment of FIGS. 5 and 6, the coatings 7c on the protrusions 4a of the substrate 4 can be transferred to the print object 5.

That is, coating patterns can be formed through the steps of: a) applying coatings onto a flat plate; b) bringing the coatings on the flat plate into contact with protrusions of a substrate, the substrate composed of the protrusions and grooves, to transfer portions of the coatings on the flat plate which are in contact with the protrusions of the substrate to the protrusions of the substrate from the flat plate; and c) bringing the coatings on the protrusions of the substrate into contact with the print surface of the print object to transfer the coatings to the print object.

The second embodiment is the same as the first embodiment shown in FIGS. 1 to 6 except that the position of the flat plate and the position of the substrate having the unevenness are exchanged in order that the substrate having the unevenness directly transfers coating patterns to the print object.

However, it is preferable that the substrate having an unevenness is formed of materials which have lower absorptivity to coating than materials of the print object 5. For example, the substrate having the unevenness is preferably formed of metal, such as aluminum and stainless steel, or silicide, such as glass. Formed of such material, the substrate having unevenness goes through surface treatment by which the surface energy is raised or the print object goes through surface treatment by which the surface energy is lowered, thereby in either cases, allowing easier transfer of coatings onto the print object.

In the invention, examples of the coatings include, but are not limited to an optical ink used to form a color filter for TFT-LCD, a metal solution for wires used to form electronic circuits, a functional resin such as a conductive paste or a resist, and an adhesive and a glue capable of satisfying precision patterning. As described above, all solution of liquid state can be used as coatings in the invention. However, it is preferable that the coatings do not react the flat blanket and, particularly, the flat blanket formed of silicon materials. Examples of the optimum device that is capable of being applied to the invention may include a color filter process for LCD(liquid crystal display), a TFT (thin film transistor) circuit process for LCD, a PDP (plasma display panel) filter process, a PDP upper and lower plate electrode process, a device for producing a PDP partition, a catalyst micropatterning device for electrochemical deposition, a lithography device for semiconductors, a selective hydrophilic and hydrophobic treatment device, and a device for selectively applying a sealant that is used in a flexible display or an E-paper.

In the present invention, when coating patterns transferred to the print object 5 are formed, a convection oven, a hot plate, or a UV exposing machine may be used, but drying methods in the art may be used, but the invention is not limited to these methods. The coating patterns are solidified by the drying method, and the patterns can endure external physical and chemical changes.

Furthermore, in the method of the invention, when the flat plate and the substrate having the unevenness are pressed against each other, or the flat plate and the print object, or the substrate having the unevenness and the print object, it is preferable that uniform pressure (10^{—2} to 10³ Mpa) be applied to the contact surfaces of the substrate having the unevenness, the flat plate, and the print object. When the flat plate and the substrate having the unevenness are pressed at excessively high pressure, the flat plate may come into contact with the bottom of the substrate having the unevenness. The dissolution regarding determination of the pressure must be 1/1000 or more of the allowable minimum pressure. When the flat plate comes close to the substrate having the unevenness, or when the flat plate comes close to the print object, or when the substrate having the unevenness comes close to the print object, it is preferable to perform the pressing while alignment is performed using fine pressure.

In this case, it is possible to form the uniform coating patterns having the high precision on the print object. In the invention, electrical or optical compression sensing process may be performed to apply uniform pressure to the entire contact surface.

With respect to the electric process, a piezodielectric sensor(piezodielectric transducer(PZT) or piezodielectric quartz crystal) may be used. For example, the piezodielectric sensor is mounted on at least two portions, and preferably three portions, of the flat blanket support parts to electrically convert the pressure resulting when the flat blanket is pressed against the substrate having the unevenness, or when the flat blanket is pressed against the print object, thereby applying the uniform pressure to the entire contact surface.

In addition, with respect to the optical process, the laser interferometer may be used. For example, the laser interferometer maybe provided on at least two portions, and preferably three portions, of the flat blanket support parts to set an access distance to the nanometer (nm) level, when the flat blanket comes close to the substrate having the unevenness, or when the flat blanket comes close to the print object. The access distance of a few tens nanometers may be detected between the flat blanket and the substrate having the unevenness and between the flat blanket and the print object using a Moire pattern in the laser interferometer. Detection precision is increased as an interval of precision gratings having the cycle used in interference is reduced.

According to the method of the invention, it is possible to precisely form the uniform pattern of the coatings on the large surface. The above-mentioned piezodielectric sensor and the laser interferometer have not been used in the art. However, the piezodielectric transducer and the laser interferometer, which are typically used in industrial processes of other fields, may be applied to the method of the invention.

Hereinafter, another embodiment of the present invention will be described.

The embodiment is the same as the first embodiment shown in FIGS. 1 to 6 except that coatings 17a are filled in grooves 14b of a substrate 14, and the coatings 17a in the grooves 14b are transferred to the flat plate 12 and 13, and then the coatings 17a on the flat plate 12 and 13 are printed on a print object 15.

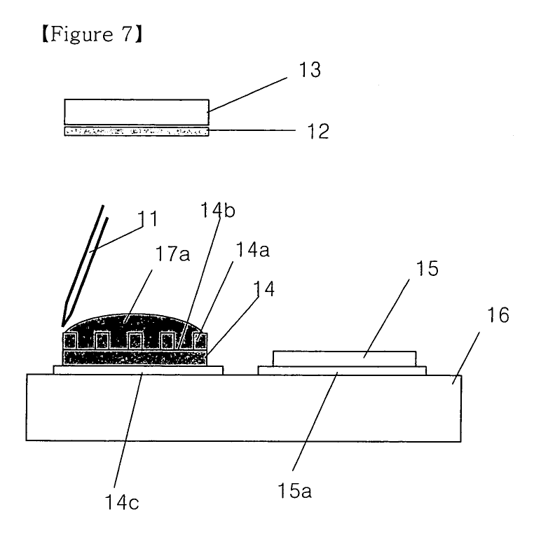

FIG. 7 is a view showing the process of filling the coating s 17a in the grooves 14b of the substrate 14 having the grooves 14b.

The method of filling the coatings 17a in the grooves 14b of the substrate 14 is limited, and a doctor blade method may be used according to the embodiment.

First, the coatings 17a are applied to the surface of the substrate 14 having the grooves 14b between protrusions 14a.

The applying of the coatings 17a is not limited to a specific method, a method of evenly applying coatings to the substrate 14 having the grooves 14b using nozzles having an uniform filling amount, such as a capillary and a slit coater may be used.

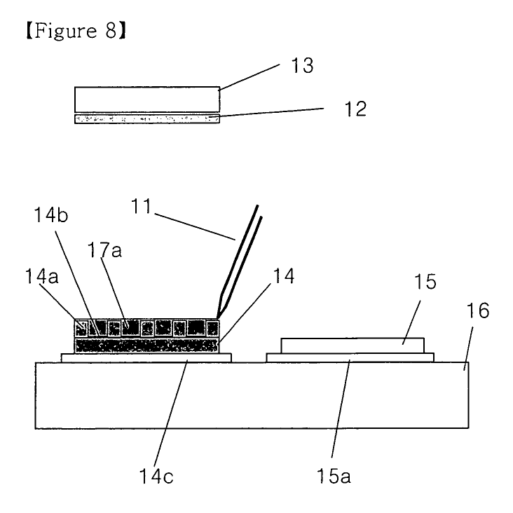

A doctor blade 11 functions as a filling amount control means, which is provided in order that the coatings 17a are exclusively filled in the grooves 14b of the substrate 14, and removes the coatings located outside the grooves. In this case, it is preferable that the doctor blade 11 has a structure so as to be easily brought into contact with the substrate 14 having the grooves 14b and is formed of soft materials. FIG. 8 is a view showing the case in which the coatings 17a are filled exclusively in the grooves 14b.

The substrate 14 having the grooves 14b may be formed of any material as long as the material has lower absorptivity to coatings than material of the flat plate 12 and 13.

Since the flat plate 12 and 13 having heteromorphism should be pressed by the substrate 14 having the grooves 14b in order to effectively transfer ink, the substrate 14 having the grooves 14b is preferably formed of metalic materials such as aluminum and stainless steel, and silicide like glass.

The substrate 14 having the grooves 14b may be disposed on a substrate support part 14c, and the substrate 14 is attached to the substrate support part 14c in vacuum.

The substrate 14 having the grooves 14b can be mounted on a support part fixing frame 16 that is disposed in a position required in the process by using the substrate support part 14c, the position of theses can be fine-controlled by moving them in the upward and downward, right and left, forward and backward, and rotation directions. Positions of the substrate 14 having the grooves 14b and the print object 15 may be controlled through the same procedure as the position control of the above-mentioned flat plates 2, 3, 12, and 13, that is, using the device shown in FIGS. 13 and 14.

The support part fixing frame 16 functions to support the substrate 14 having the unevenness and the print object 15 from below, and is capable of being moved in all directions including x-, y-, z-, and θ-axis directions. Thus, it is convenient to simultaneously move the substrate 14 having the unevenness and the print object 15 by the same distance.

The substrate 14 having the unevenness and the print object 15 may be conveyed to the support part fixing frame 16 using a movement device including a conveyer and a driving arm.

After the coatings 17a are filled in the grooves 14b of the substrate 14, the flat plate 12 and 13 is pressed against the surface of the substrate 14 having the grooves 14b.

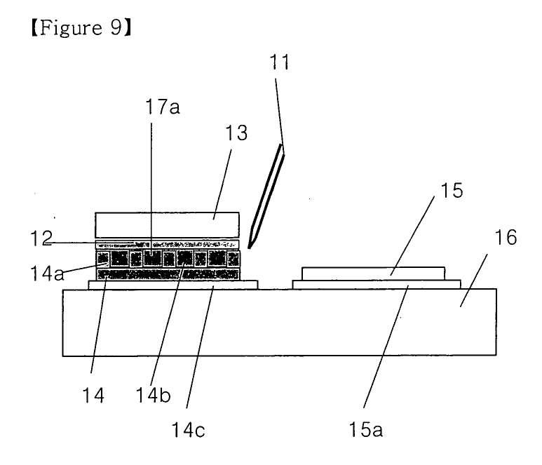

This process is shown in FIG. 9, when the flat plate 12 and 13 is pressed against the substrate 14 having the grooves 14b, it is preferable that uniform pressure (10^{—2} to 10³ Mpa) be applied to the contact surfaces of the flat plate and the substrate having the grooves.

When uniform pressure is applied, consistency and precision of coatings can be improved. The flat plate 12 and 13 and the substrate 14 having the grooves 14b come into vertical contact with the contact surface to improve precision.

In the present invention, the flat plate 12 and 13 is composed of a flat blanket 12 and a flat blanket support part 13 capable of supporting the flat blanket 12.

The flat blanket 12 can be attached to the flat blanket support part 13 in vacuum, accordingly, the flat blanket 12 can be firmly fixed to the flat blanket support part 13.

The flat blanket 12 can move together with the flat blanket support part 13 in the upward and downward, the right and left, and the forward and backward directions, and rotate (refer to FIGS. 13 and 14).

Since the flat blanket 12 is evenly attached to the flat blanket support part 13, it is more likely that the flat blanket 12 is prevented from bending, as compared to the case of using a roll.

The flat blanket 12 is preferably formed of materials which have heteromorphism and resilience when pressure is applied thereto. It is only with the materials having heteromorphism and resilience that the flat blanket 12 can come into tight contact with the substrate 14 having the grooves 14b, and the coatings 17a filled in the grooves 14b can reliably transferred to the flat blanket 12.

Preferably, materials of the flat blanket 12 have higher absorptivity to the coatings than the substrate 14 having the grooves 14b, but lower absorptivity to the coatings 17a than the print object 15. Therefore, in the present invention, the flat blanket 12 is preferably formed of silicon based rubber.

The flat blanket support part 13 increases in size, the increase of weight is small, as compared to the case of using the roll. Therefore, the flat blanket support part 13 has higher durability, as compared to the case of using the roll.

In addition, if the flat blanket support part 13 is formed in a thin shape by using inorganic materials such as natural stone like marble, which is not deformed due to gravity and its own weight, and ceramic or stainless steel, it is possible to further improve durability of the flat blanket support part 13.

This is because the inorganic materials such as marble and ceramic are immune to deformation that occurs in metallic or polymer materials.

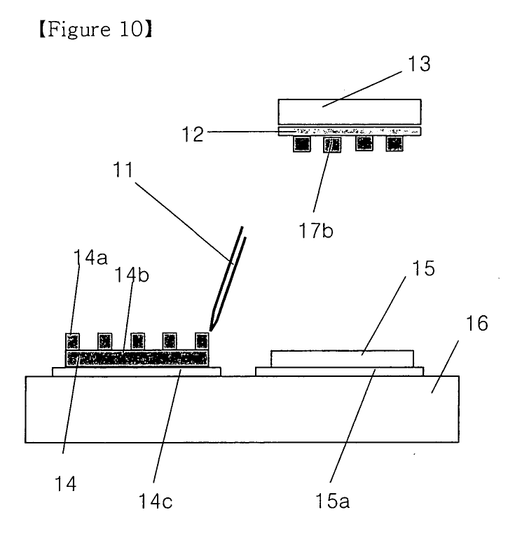

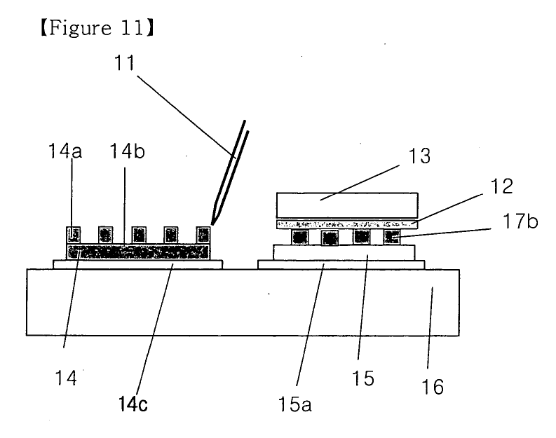

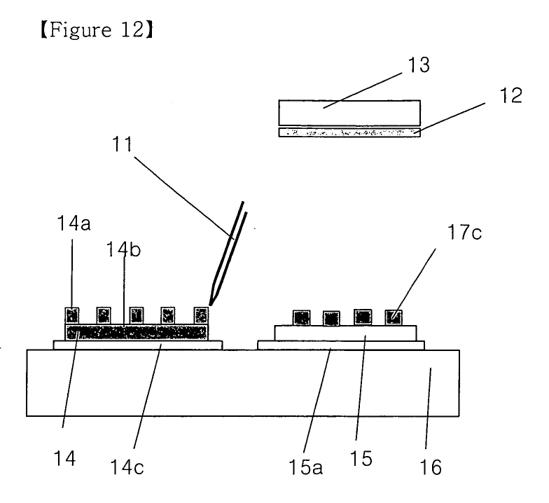

The coatings 17b transferred to the flat blanket 12 are brought into contact with the print object 15 so as to be transferred to the print object 15, and this process is shown in FIGS. 10 to 12.

In this step, preferably, the flat plate 12 and 13 and the print object 15 come into vertical contact with the contact surface, and uniform pressure is applied to the entire contact surface, to improve consistency and precision of forming patterns of the coatings 17b.

Preferably, materials of the print object 15 have higher absorptivity than the flat blanket 12, and the material having the hard surface, such as glass, and the polymer material that has the flexible surface, such as polyethylene, polypropylene, or polyvinyl, may be used as the print object 15.

The print object 15 can be mounted on a print object support part 15a, and the print object 15 can be attached to the print object support part 15a in vacuum.

The print object 15 can be mounted on the support part fixing frame 16 that is disposed in a position required in the process by using the print object support part 15a, the position of theses can be fine-controlled by moving them in the upward and downward, right and left, forward and backward, and rotation directions.

With the above-describe method, it is possible to precisely form the uniform pattern of the coatings on the large surface.

1. A method for patterning coatings comprising the steps of:
a) applying coatings onto a flat plate;
b) allowing the coatings applied to the flat plate to contact with protrusions of a substrate so as to transfer portions of the coatings on the flat plate which contact with the protrusions of the substrate to the protrusions of the substrate from the flat plate, the substrate having unevenness formed with the protrusions and grooves; and
c) allowing the coatings remaining on the flat plate or on the protrusions of the substrate to contact with a print surface of a print object so as to transfer the coatings to the print object.

2. The method according to claim 1,
wherein the flat plate includes a flat blanket provided for applying coatings, and a flat blanket support part supporting the flat blanket.

3. The method according to claim 2,
wherein the flat blanket is formed of silicon rubber, and the flat blanket support part is formed of inorganic materials or stainless steel.

4. The method according to claim 1,
wherein the substrate having the unevenness and the print object are attached to a substrate support part and a print object support part in vacuum, respectively.

5. The method according to claim 1,
wherein the substrate having the unevenness is formed of metallic materials or silicide.

6. The method according to claim 1,
wherein the print object is formed of any one of glass material, flexible plastic material, and hard plastic material.

7. The method according to claim 1,
wherein the contacting surfaces contact with each other in a vertical direction relative to the surfaces in the steps b) or c).

8. The method according to claim 1, further comprising:
controlling the contacting in the step b) or c) by an electrical or optical compression sensing process so as to apply uniform pressure to the entire contact surface.

9. The method according to claim 8,
wherein the electrical or optical compression sensing process utilizes a piezodielectric sensor or a laser interferometer.

10. The method according to claim 1,
wherein the coatings includes a functional material selected from groups composed of an optical ink, a metal solution for wires, a conductive paste or a resist, and an adhesive and a glue.

11. A method of manufacturing an electronic device by finely patterning an electronic material using the method according to claim 1.

12. The method according to claim 11,
wherein the electronic device is a component of an electromagnetic recording device, an imaging device or a circuit device.

13. A method for patterning coatings comprising the steps of:
a) filling coatings into grooves of a substrate;
b) allowing a flat plate to contact with the surface of the substrate having the grooves so as to transfer the coatings filled in the grooves to the flat plate; and
c) allowing the coatings transferred to the flat plate to contact with a print surface of a print object so as to transfer the coatings on the flat plate to the print object.

14. The method according to claim 13,
wherein the flat plate includes a flat blanket and a flat blanket support part supporting the flat blanket.

15. The method according to claim 14,
wherein the flat blanket is formed of silicon rubber, and the flat blanket support part is formed of inorganic materials or stainless steel.

16. The method according to claim 13,
wherein the substrate having the grooves and the print object are attached to a substrate support part and a print object support part in vacuum, respectively.

17. The method according to claim 13,
wherein the compressing surfaces or the contacting surfaces contact with each other in a vertical direction relative to the surfaces in the steps b) or c).

18. The method according to claim 13, further comprising:
controlling the contacting in the step b) or c) by an electrical or optical compression sensing process so as to apply uniform pressure to the entire contact surface.

19. The method according to claim 18,
wherein the electrical or optical compression sensing process utilizes a piezodielectric sensor or a laser interferometer.

20. The method according to claim 13,
wherein the coatings include a functional resin selected from groups composed of an optical ink, a metal solution for wires, a conductive paste or a resist, and an adhesive and a glue.

21. A method of manufacturing an electronic device by finely patterning an electronic material using the method according to claim 13.

22. The method according to claim 21,
wherein the electronic device is a component of an electromagnetic recording device, an imaging device or a circuit device.

23. An apparatus for patterning coatings comprising:
a flat plate which is provided so as to be movable in x-, y-, z-, and θ-axis directions with respect to a surface of the flat plate by a flat movement device;
a coater which is provided so as to be movable along a surface direction of the flat plate by a coater movement device so as to apply coatings onto the flat plate; and
a substrate which is disposed below the flat plate and includes protrusions,
wherein the flat plate is conveyed so as to contact with the substrate, the coatings on the flat plate is transferred to the protrusions of the substrate, and then the coatings remaining on the flat plate or on the protrusions of the substrate is transferred to a print object, thereby forming patterns.

24. The method according to claim 23,
wherein the flat movement device includes:
a first movement device having a movement support frame which guides the movement of the flat plate, and a first control screw which is disposed in the movement support frame and controls the movement of the flat plate in z-axis direction with respect to the surface of the flat plate; and
a second movement device having second and third control screws which are disposed in the flat plate, and control the movement of the flat plate in x-, y-, and θ-axis directions along the surface direction of the flat plate.

25. The apparatus according to claim 24,
wherein the flat movement device may further include a stepping motor which is joined with at least one of the first control screw, the second control screw, and the third control screw.

26. The apparatus according to claim 23,
wherein the coater movement device includes:
a coater mounting frame on which the coater is mounted; and
a linear motor which moves the mounting frame having the coater mounted therein in the right and left direction.

27. The apparatus according to claim 23, further comprising
a support part fixing frame which supports the substrate and the print object from below.

28. An apparatus for patterning coatings comprising:
a flat plate which is provided so as to be movable in x-, y-, z-, and θ-axis directions with respect to a surface of the flat plate by a flat movement device;
a substrate which is disposed below the flat plate and formed with grooves capable of filling coatings therein; and
a filling amount control means which is provided in order that the coatings is exclusively filled in the grooves of the substrate,
wherein the flat plate is conveyed toward the substrate, in which the coatings is exclusively filled in the grooves by the filling amount control means, and the coatings filled in the grooves are transferred to the flat plate by pressing the flat plate against the substrate, and then the coatings on the flat plate are transferred to a print surface of a print object by conveying the flat plate, thereby forming patterns.

29. The apparatus according to claim 28,
wherein the flat movement device includes:
a first movement device having a movement support frame which guides the movement of the flat plate, and a first control screw which is disposed in the movement support frame and controls the movement of the flat plate in z-axis direction with respect to the surface of the flat plate; and
a second movement device having second and third control screws which are disposed in the flat plate, and control the movement of the flat plate in x-, y-, and θ-axis directions along the surface direction of the flat plate.

30. The apparatus according to claim 29,
wherein the flat movement device may further include a stepping motor which is joined with at least one of the first control screw, the second control screw, and the third control screw.

31. The apparatus according to claim 28, further comprising:
a support part fixing frame which supports the substrate and the print object from below.
